(19) United States
(12) Patent Application Publication
(10) Pub. No.: US 2006/0187319 A1
(43) Pub. Date: Aug. 24, 2006

(54) Image capturing apparatus

(75) Inventors: Tougo Teramoto, Wakayama-shi (JP); Shinichi Ban, Kobe-shi (JP); Katsuyuki Nanba, Sakai-chi (JP); Toshihiro Hamamura, Yokohama-shi (JP)

Correspondence Address: SIDLEY AUSTIN LLP, 717 NORTH HARWOOD, SUITE 3400, DALLAS, TX, 75201, US

(73) Assignee: KONICA MINOLTA PHOTO IMAGING, INC.

(21) Appl. No.: 11/241,092

(22) Filed: Sep. 30, 2005

(30) Foreign Application Priority Data
Feb. 21, 2005 (JP) JP2005-043773

(51) Int. Cl. H04N 5/76

(52) U.S. Cl. 348/231.99

(57) ABSTRACT

An image capturing apparatus receives subject information stored in an IC tag provided for a subject by performing radio communication with the IC tag, and controls an image capturing operation on the basis of the acquired subject information. For example, the image capturing apparatus sets a color correction parameter and controls white balance on the basis of information on colors of the subject included in the subject information stored in the IC tag.

This application is based on application No. 2005-043773 filed in Japan, the contents of which are hereby incorporated by reference.

### BACKGROUND OF THE INVENTION

1. Field of the Invention

The present invention relates to an image capturing apparatus that performs communication with an IC tag.

2. Description of the Background Art

In recent years, as a commodity identifying technique or commodity managing technique replacing a bar code, a system using an RFID tag (IC tag) is being used. The RFID tag can store attribute information such as identification (ID) number, price and the like of a target to which the RFID tag is attached. The attribute information stored in the RFID tag can be read through radio communication using an RFID tag reader.

There is a proposed technique of providing an image capturing apparatus with such an RFID tag reader and capturing an image of a subject having an RFID tag by using the image capturing apparatus, thereby acquiring image data and, also, acquiring information of the subject (also referred to as “subject information”) (see Japanese Patent Application Laid-Open No. 2003-174578).

However, there is no technique having the viewpoint of performing an image capturing operation in accordance with a subject by an image capturing apparatus which acquires subject information from an RFID tag provided for the subject. For example, the image capturing operation of the image capturing apparatus is performed with a setting operation independent of the subject information in both of the case where a manual setting operation by a user accompanies and the case where an automatic setting operation by the image capturing apparatus accompanies. Consequently, the subject information is not reflected on the image capturing operation.

### SUMMARY OF THE INVENTION

An object of the present invention is to provide a technique of performing an image capturing operation in accordance with a subject by using subject information obtained through communication with an IC tag provided for the subject.

In order to achieve this object, according to a first aspect of the present invention, an image capturing apparatus comprises a receiver for receiving subject information stored in an IC tag provided for a subject by performing wireless communication with the IC tag, and a controller for controlling an image capturing operation on the basis of the subject information received by the receiver.

The present invention is also directed to a method for controlling the image capturing apparatus.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram showing the configuration of an RFID tag attached to a subject;

FIG. 2 is a diagram showing an example of tag information stored in the RFID tag;

FIGS. 3A and 3B are diagrams showing an appearance configuration of the image capturing apparatus;

FIG. 4 is a block diagram showing internal functions of the image capturing apparatus;

FIG. 5 is a diagram showing an internal configuration of an RFID tag reader;

FIG. 6 is a flowchart showing operations of the image capturing apparatus;

FIG. 7 is a diagram showing an indication of warning regarding inhibition of image capturing;

FIG. 8 is a diagram showing the configuration of an image file;

FIG. 9 is a flowchart showing a white balance adjusting operation;

FIG. 10 is a diagram showing color adjustment using a color correction parameter;

FIG. 11 is a flowchart showing an exposure control value adjusting operation;

FIG. 12 is a flowchart showing a focal length adjusting operation;

FIG. 13 is a diagram showing the relation between the focal length and the size of a subject;

FIG. 14 is a diagram showing an image captured with relatively small focal length;

FIG. 15 is a diagram showing an image captured with relatively large focal length;

FIG. 16 is a flowchart showing a focus adjusting operation;

FIG. 17 is a diagram showing an AF area selecting operation;

FIG. 18 is a diagram showing the AF area selecting operation;

FIG. 19 is a diagram showing a playback screen;

FIG. 20 is a state transition diagram in a playback mode;

FIG. 21 is a diagram showing a warning display screen regarding copying inhibition; and

FIG. 22 is a diagram showing a warning display screen regarding erasure inhibition.

### DESCRIPTION OF THE PREFERRED EMBODIMENTS

Preferred embodiments of the present invention will be described below with reference to the drawings.

1. System Configuration

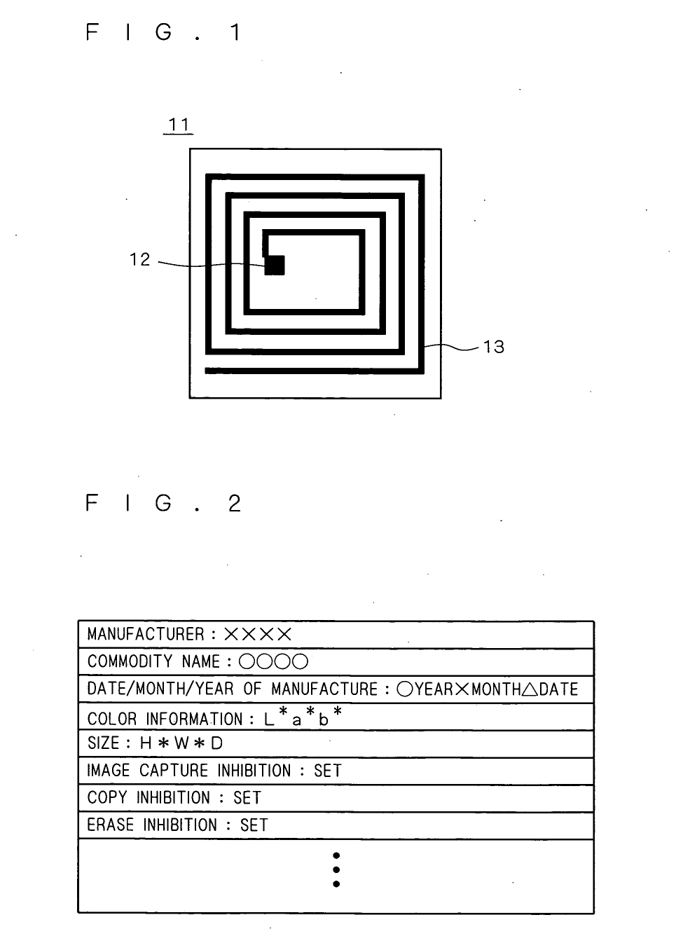

FIG. 1 is a diagram showing the configuration of an RFID tag (IC tag) 11 attached to a subject. FIG. 2 is a diagram showing an example of information (hereinafter, also referred to as “tag information”) stored in an IC chip 12 in the RFID tag 11.

As shown in FIG. 1, the RFID tag 11 includes the IC chip 12 and a tag antenna 13. The IC chip 12 is constructed by a packaged semiconductor integrated circuit and can hold (store) tag information as shown in FIG. 2. The tag information includes information related to the subject (hereinafter, also referred to as “subject information”) to which the RFID tag 11 is attached. The subject information includes attribute information indicative of attributes of the subject himself/herself and designation information that designates operations on an image of the subject. The former attribute information includes, for example, the manufacturer of a commodity as the subject, the commodity name, the date/month/year of manufacture, color information, commodity size and the like. The latter designation information includes, for example, image capturing inhibition information, copying inhibition information, erasure inhibition information and the like.

The RFID tags can be of a passive type having therein no power supply and transmitting tag information by using energy of electric waves transmitted from an external reader/writer or an active type having therein a power supply and capable of actively transmitting tag information.

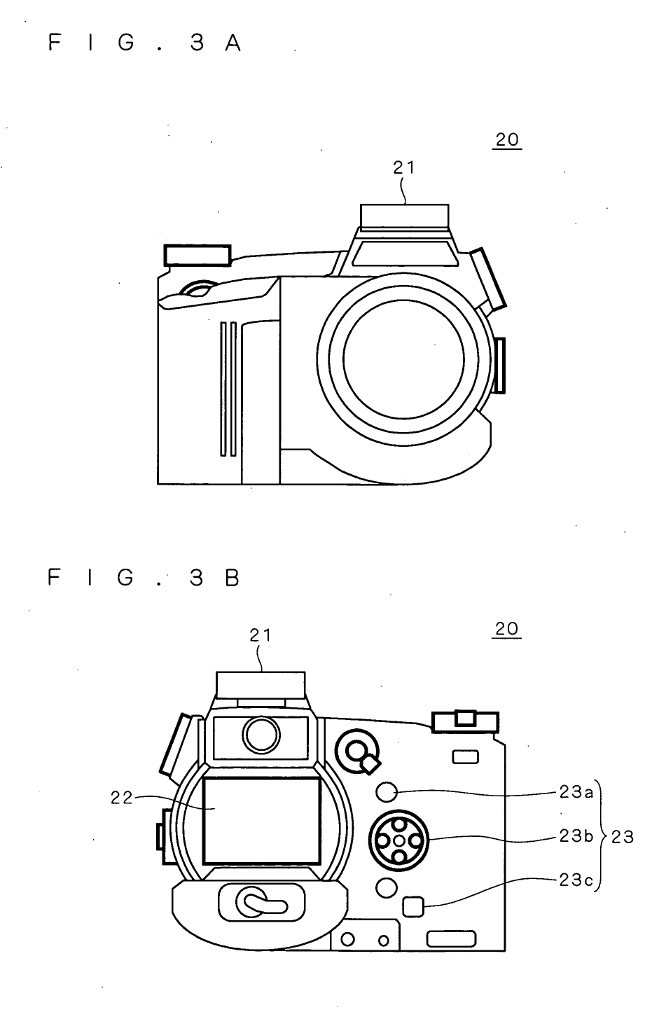

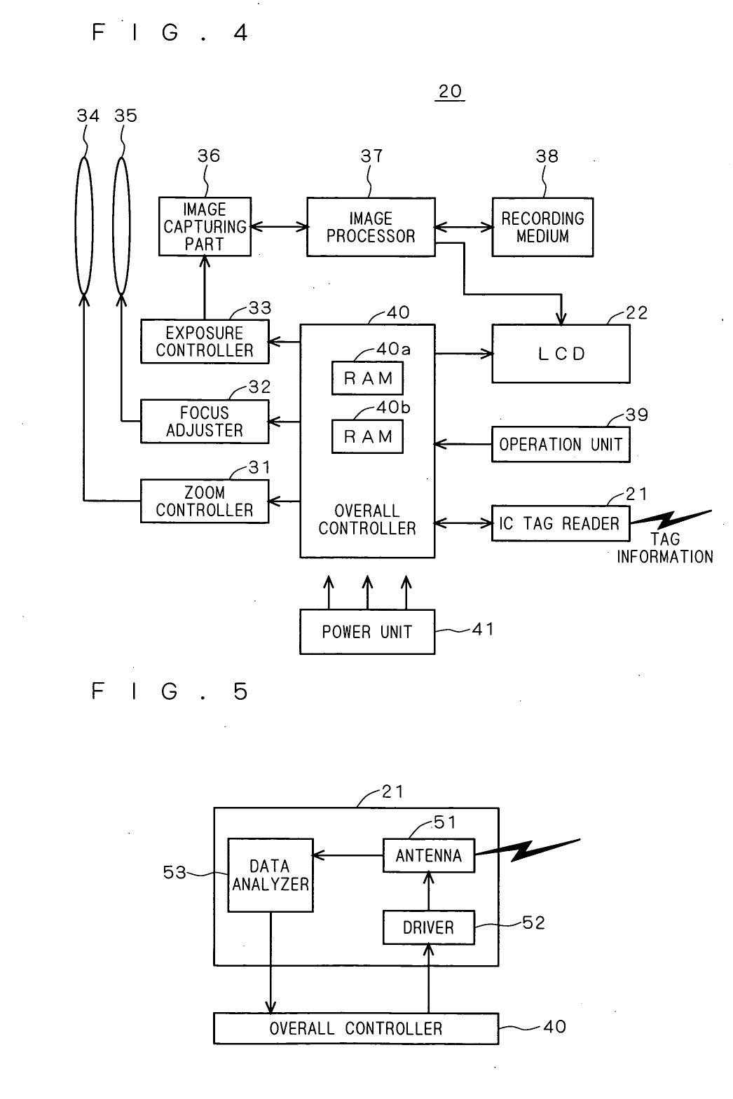

FIGS. 3A and 3B are a front view and a rear view, respectively, showing the appearance configuration of an image capturing apparatus 20 according to the present invention.

As shown in FIGS. 3A and 3B, the image capturing apparatus 20 has, on its rear face, an LCD 22 and an operation button unit 23 and has, on its top, an RFID tag reader 21 and a shutter release button (release SW) (not shown). The RFID tag reader 21 is removably attached to an accessory shoe (electronic flash shoe) provided on the top of the image capturing apparatus 20. The position of attachment of the RFID tag reader 21 is not limited to the accessory shoe (electronic flash shoe). For example, the RFID tag reader 21 may be provided in the image capturing apparatus 20.

The RFID tag reader 21 is a device capable of performing radio communication (wireless communication) with the RFID tag 11 via electric waves and has the function of acquiring tag information recorded on the RFID tag 11. The RFID tag reader 21 also supplies power to the RFID tag 11 of the so-called passive type. The internal configuration of the RFID tag reader 21 will be described later.

The LCD 22 in FIG. 3B is a display constructed by using a liquid crystal and a light source. On the LCD 22, display of a live view, playback of a recorded image, display of a setting menu, and the like are performed.

The operation button unit 23 includes a menu button 23a for setting operation environments of the image capturing apparatus 20, a four-way key 23b used for a zooming operation and the like, and a image-capturing/playback mode selection switch 23c for selecting an operation mode of the image capturing apparatus 20.

The internal configuration of the image capturing apparatus 20 will now be described. FIG. 4 is a block diagram showing the internal function of the image capturing apparatus 20.

A zoom controller 31 has the function of driving a zoom lens 34 existing in a lens optical system in response to an instruction of the operator (user) to change the focal length (that is, the angle of view or zoom magnification). A focus adjuster 32 has the function of driving a focus lens 35 existing in the lens optical system to obtain a focus state on the subject.

An exposure controller 33 has the function of adjusting exposure control for adjusting a captured image to proper brightness by adjusting the aperture and the exposure time (shutter speed) of an image capturing device (for example, CCD) (not shown) in an image capturing unit 36.

A subject image input via the lens optical system is photoelectrically converted by the image capturing device (CCD) in the image capturing unit 36. The resultant is A/D converted to a digital signal, and the digital signal is acquired as image data. The image data is subjected to white balance correction, y correcting process and the like in an image processor 37.

After that, the processed image data is written in a recording medium (memory card or the like) 38 or displayed as a live view image on the LCD 22.

An operation unit 39 is constructed by a button, a switch and the like which can be operated by the user. Concretely, the operation unit 39 includes the operation button unit 23, a power switch for switching on/off of the power supply, and a shutter button (release SW) used by the user to instruct an image capturing timing. The shutter button (release SW) functions as a two-level press switch capable of detecting a half-pressed state (hereinafter, also referred to as S1 state) and a depressed state (hereinafter, also referred to as S2 state) achieved by the user operation. When the depressed state (S2) is detected, it is determined that the release SW is turned on (ON) and the image capturing operation is started.

A power unit 41 used as a power supply source supplies operation power to each of the components such as an overall controller 40 of the image capturing apparatus 20.

The overall controller 40 is constructed by a microcomputer having a RAM 40a and a ROM 40b and has the function of collectively controlling the components by executing a control program pre-stored in the ROM 40b by the microcomputer.

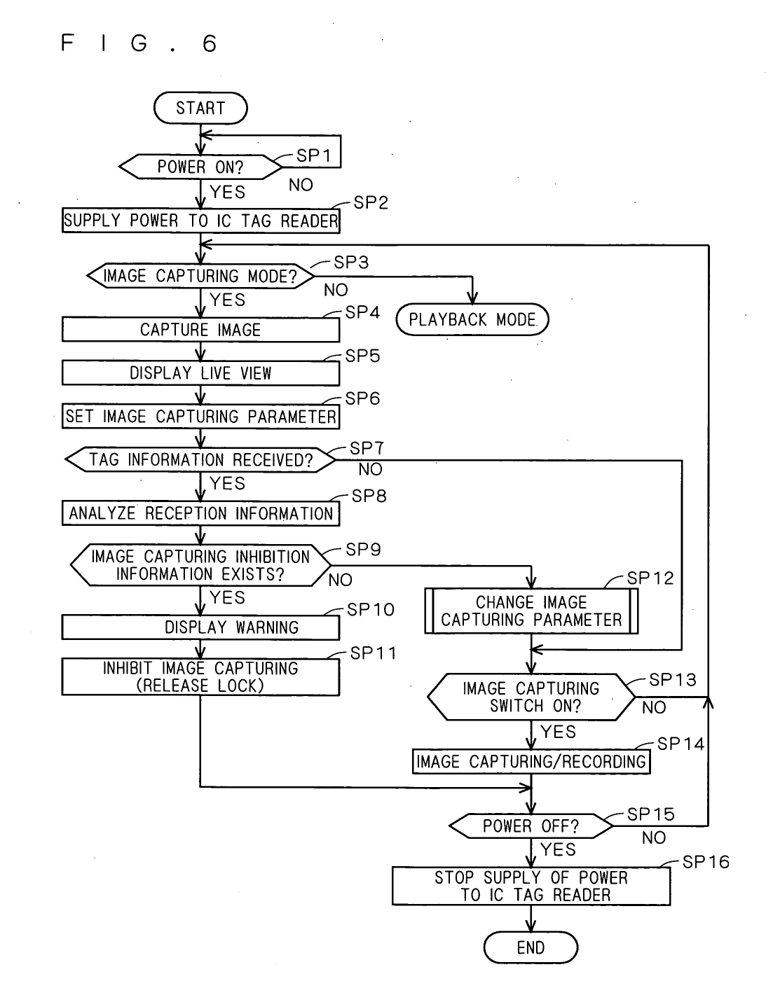

Next, the RFID tag reader 21 will now be described. FIG. 5 is a diagram showing an internal configuration of the RFID tag reader 21.

As shown in FIG. 5, the RFID tag reader 21 has a narrow-directional antenna 51 (hereinafter, also referred to as “antenna”), a driver 52, and a data analyzer 53.

The antenna 51 functions as an antenna used for communication with the RFID tag 11 and has considerably strong directivity (narrow directivity) in one direction. The driver 52 has the (scan drive) function of driving the antenna 51 to scan a region (hereinafter, also referred to as “scan region RS”) designated by the overall controller 40. A region where communication with the image capturing apparatus 20 is performed in the depth of field (hereinafter, also referred to as “communication target region”) can be freely adjusted by the overall controller 40. That is, since the scan region RS corresponds to the communication target region, by changing the position and size of the scan region RS in the antenna 51, the communication target region can be changed.

Information acquired from the RFID tag 11 through communication is analyzed by the data analyzer 53 and transmitted to the overall controller 40.

The image capturing apparatus 20 controls an image capturing operation on the basis of subject information acquired from the RFID tag 11 as will be described below. Consequently, the image capturing operation according to the subject can be performed.

The operations of the image capturing apparatus 20 having the above-described functions will be described below.

2. Operations

Image Capturing Operation

FIG. 6 is a flowchart showing an image capturing operation and the like of the image capturing apparatus 20.

First, when the power of the image capturing apparatus 20 is turned on by the operator (user) (step SP1), power is supplied to the RFID tag reader 21 and it allows the image capturing apparatus 20 to perform communication with the RFID tag 11 (step SP2).

Next, which one of the playback mode and the image capturing mode is selected is determined (step SP3). In the case where the playback mode is selected, the image capturing apparatus 20 shifts to the playback mode and performs processes of the playback mode. In the case where the image capturing mode is selected, the image capturing apparatus 20 shifts to the image capturing mode and performs processes of step SP4 and subsequent steps. Herein, description will be continued on assumption that the image capturing mode is selected.

In step SP4, a live view image is captured by the image capturing unit 36. The subject image captured by the image capturing unit 36 is subjected to predetermined processes in the image processor 37 and the like, and the resultant is displayed as a live view on the LCD 22 (step SP5). By using the information of the live view image, image capturing parameters such as a color correction parameter (gain for color correction) and exposure control values (aperture, shutter speed, and ISO sensitivity) are determined, and a focusing operation is performed, thereby determining a focus lens position (step SP6). The image capturing parameters determined in step SP6 are determined on the basis of data other than the tag information (subject information), and the tag information (subject information) is not reflected. As will be described later, the image capturing parameters determined in step SP6 may be changed in step SP12 before the image capturing operation.

After that, it is determined in step SP7 whether tag information of the RFID tag 11 provided for the subject is received by the RFID tag reader 21 in the image capturing apparatus 20 or not.

In the case where the tag information is not received, except for the case where depression of the shutter button (image capturing switch) is determined (step SP13), the program returns to step SP3. When depression of the shutter button is determined, an operation of recording the captured image (step SP14) is performed.

On the other hand, when tag information is received, the program advances to step SP8 where the received tag information is analyzed by the data analyzer 53. In such a manner, subject information of the subject to be photographed is acquired. After that, whether image capturing inhibition information exists in the received tag information or not is determined (step SP9).

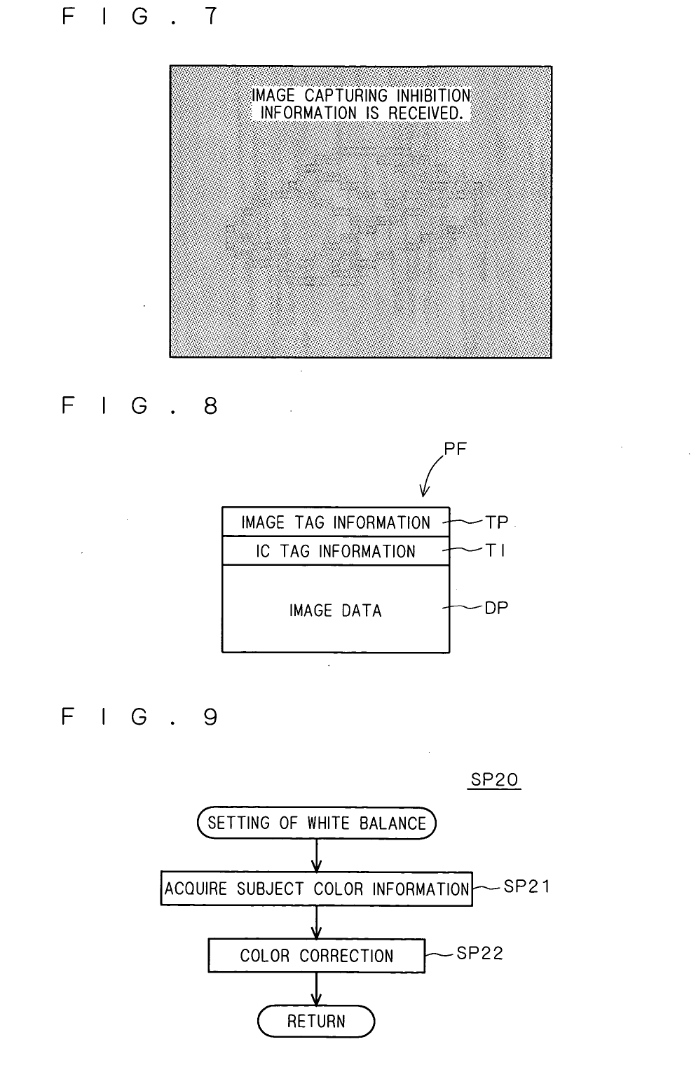

In the case where the image capturing inhibition information exists (more specifically, in the case where inhibition of capturing an image of the subject is specified in that tag information of the subject), the image capturing apparatus 20 displays warning of inhibition of capturing an image of a subject as shown in FIG. 7 for a predetermined period (for example, a few seconds) on the LCD 22 (step SP10) and inhibits the image capturing operation by release lock (step SP11). Consequently, in the case where “image capturing inhibition information” is recorded in an RFID tag provided for an exhibition (such as a picture) in a museum, image capturing of the exhibition can be avoided. FIG. 7 shows that a warning is displayed by superimposing characters of “image capturing inhibition information is received” on a live view image which is processed in mosaic.

After that, whether power is turned off or not is determined (step SP15). Except for the case where the power is turned off, the program returns to step SP3. In the case where the power is off, power supply to the RFID tag reader 21 is stopped (step SP 16) and the image capturing operation is finished.

On the other hand, when the image capturing inhibition information does not exist (specifically, when inhibition of capturing an image of a subject is not specified in the tag information of the subject), the program shifts from step SP9 to step SP12 where an image capturing parameter changing process is performed. The changing process (step SP12) will be described later.

After that, except for the case where depression of the shutter button is determined (step SP13), the program returns to step SP3. When it is determined that the shutter button is depressed, an operation of recording the captured image (step SP14) is performed.

In step SP14, data regarding the captured image is recorded as an image file PF as shown in FIG. 8. The image file PF is a file recording not only image data DP of the captured image but also image tag information TP and IC tag information TI so as to be associated with the image data DP. The image tag information TP is information including image capturing parameters (for example, aperture, shutter speed, ISO sensitivity, focal length, date and time of image capturing, and image size) at the time of capturing the captured image. The IC tag information TI is information including tag information (subject information) analyzed in step SP8. As described above, in step S14, the IC tag information TI is recorded in association with the image data DP in one image file PF.

After that, whether the power is off or not is determined (step SP15). Except for the case where the power is off, the program returns to step SP3. When the power is off, power supply to the RFID tag reader 21 is stopped (step SP16) and the image capturing operation is finished.

In such a manner, the image capturing operation in the image capturing apparatus 20 is performed.

Next, the image capturing parameter changing process (step SP12) will be described.

In step SP12, the image capturing apparatus 20 sets the image capturing parameters specifying image capturing conditions (image capturing state) on the basis of the subject information obtained in step SP8. As a result, the image capturing parameters are changed from the parameters set in step SP6 to the parameters set in step SP12.

There exist various image capturing parameters such as (1) color correction parameter, (2) exposure control value, and (3) focal length. In the following, the operation of changing the image capturing parameters will be sequentially described. Only arbitrary one of the various image capturing parameters may be set in accordance with the subject information or an arbitrary combination of a plurality of parameters may be set in accordance with the subject information.

First, the operation of setting (1) the color correction parameter will be described.

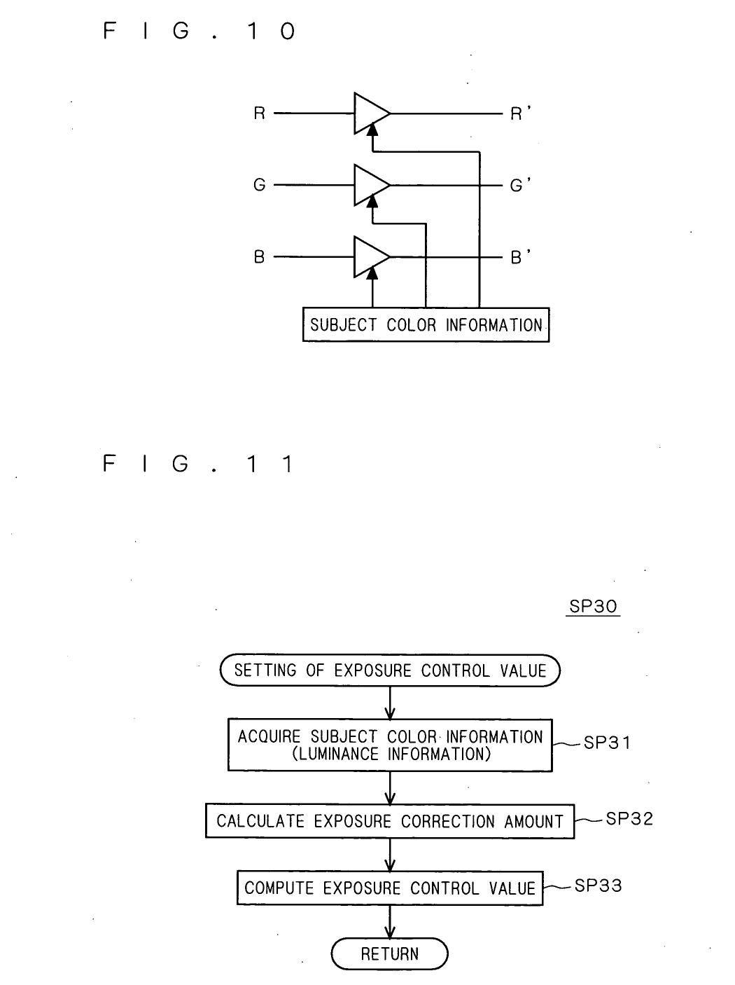

FIG. 9 is a flowchart showing an operation of setting the color correction parameter (step SP20) in step SP12.

As shown in FIG. 9, the image capturing apparatus 20 acquires information on colors of the subject (color information) from the tag information analyzed in step SP8 (step SP21) and, on the basis of the acquired color information, determines the color correction parameter (specifically, color correction gain). The “color correction parameter” is an image capturing parameter specifying white balance of a captured image.

FIG. 10 is a diagram showing color adjustment by the color correction parameter. As shown in FIG. 10, the image capturing apparatus 20 adjusts the balance of components by multiplying each of the R, G and B components with a coefficient (color correction gain). The color adjustment corresponds to adjustment of white balance.

A case is assumed that, as shown in FIG. 2, subject information in the RFID tag 11 includes color information (data expressed by, for example, the L*a*b* colorimetric system) of a product (for example, clothing, bag, car or the like) as a subject. It is assumed that information of typical one color (more specifically, color whose occupied area is the largest) in a subject is recorded as subject information.

The image capturing apparatus 20 extracts a portion of the same color having the largest occupied area in the subject in a captured image (live view image), determines the color correction gain so that the color of the extracted portion becomes a color designated by the tag information, and adjusts white balance. In the case where the designated data on the color in the tag information is expressed in the L*a*b* colorimetric system as shown in FIG. 2, it is sufficient to convert the designated data to data in the RGB colorimetric system and perform the white balance adjusting operation.

By such an adjusting operation, the white balance is controlled on the basis of the subject information (specifically, information on the color of the subject) from the RFID tag 11. Consequently, an image reproducing the color of the subject more accurately can be captured. In particular, also in the case where image capturing is performed under various environment light rays, the colors of the subject can be faithfully reproduced.

Next, the operation of setting (2) the exposure control value will be described.

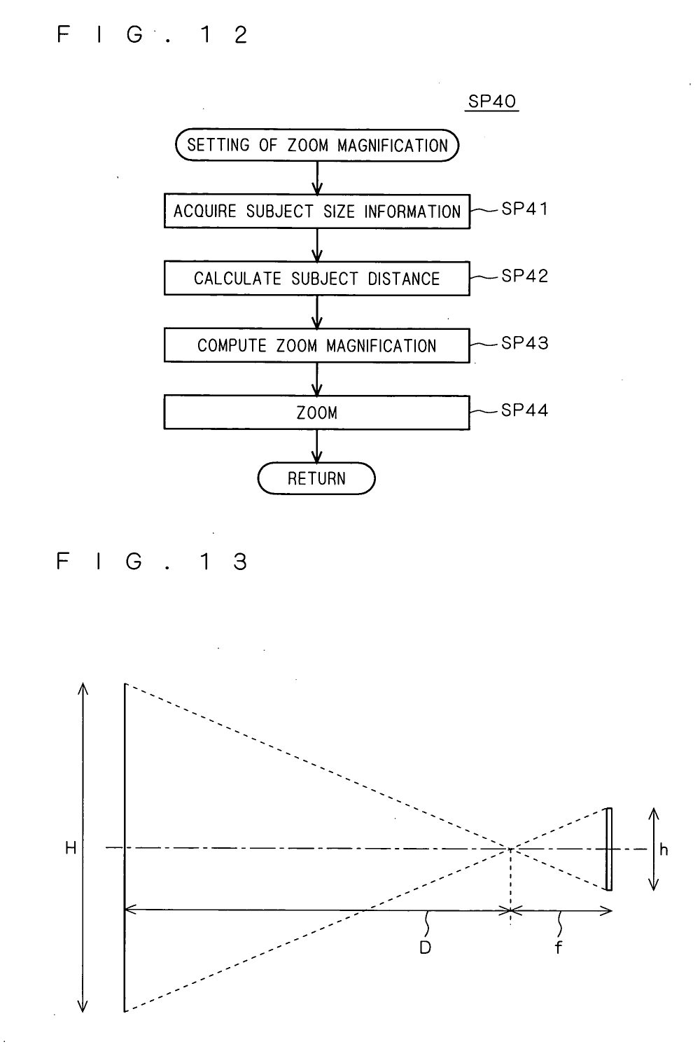

FIG. 11 is a flowchart showing the operation of setting the exposure control value in step SP12 (step SP30).

As shown in FIG. 11, the image capturing apparatus 20 acquires information on luminance (luminance information) of the subject from the tag information analyzed in step SP8, concretely, the value of a luminance value L in the color information L*a*b* (step SP31), and determines an exposure control value (aperture and shutter speed) on the basis of the acquired luminance information. The “exposure control value” is an image capturing parameter specifying an exposure state of a captured image.

It is assumed that color information (for example, data expressed in the L*a*b* colorimetric system) of one typical color of a product as a subject is recorded in the RFID tag 11 in a manner similar to the above.

The image capturing apparatus 20 extracts a portion of the same color having the largest occupied area in the subject in a captured image (live view image), and determines the exposure control value so that luminance in the color of the extracted portion becomes luminance designated by the tag information. In the case where the designated data on the color in the tag information is expressed in the L*a*b* calorimetric system as shown in FIG. 2, it is sufficient to employ, as the luminance value, the value L out of the values L, a and b.

Concretely, it is sufficient to obtain a value AV on the aperture and a value TV on the shutter speed in accordance with a predetermined program chart in a method using an APEX value. Specifically, first, the value corresponding to the luminance value (L) designated in the tag information (subject information) is obtained as the value BV and obtains the sum (BV+SV) between the value BV and the value SV on the ISO sensitivity. It is sufficient to obtain a combination between the value AV and the value TV in accordance with a predetermined program chart so that the sum (BV+SV) of the values BV and SV equals to the sum (AV+TV) of the values AV and TV.

By such an adjusting operation, the exposure control value is controlled on the basis of the subject information (specifically, information on luminance of the subject) from the RFID tag 11. Consequently, an image reproducing the luminance of the subject more accurately can be captured.

Next, the operation of setting (3) focal length will be described.

FIG. 12 is a flowchart showing the operation of setting the focal length in step SP12 (step SP40).

As shown in FIG. 12, the image capturing apparatus 20 acquires information on the size (concretely, height H, width W and depth D) of the subject from the tag information analyzed in step SP8 (step SP41), and calculates subject distance (distance from the image capturing apparatus 20 to the subject) D (step SP42). The zoom lens position corresponding to the focal length of a captured image (zoom magnification) is obtained on the basis of the acquired size information and the subject distance (D) (step SP43), and the zoom lens is moved to the obtained position (step SP44). That is, on the basis of the size information of the subject, the focal length (specifically, zoom lens position) is determined. The “focal length” is an image capturing parameter specifying the angle of view of a captured image. To simplify description, the case of determining the zoom magnification in accordance with only the height H of the product as a subject will be described.

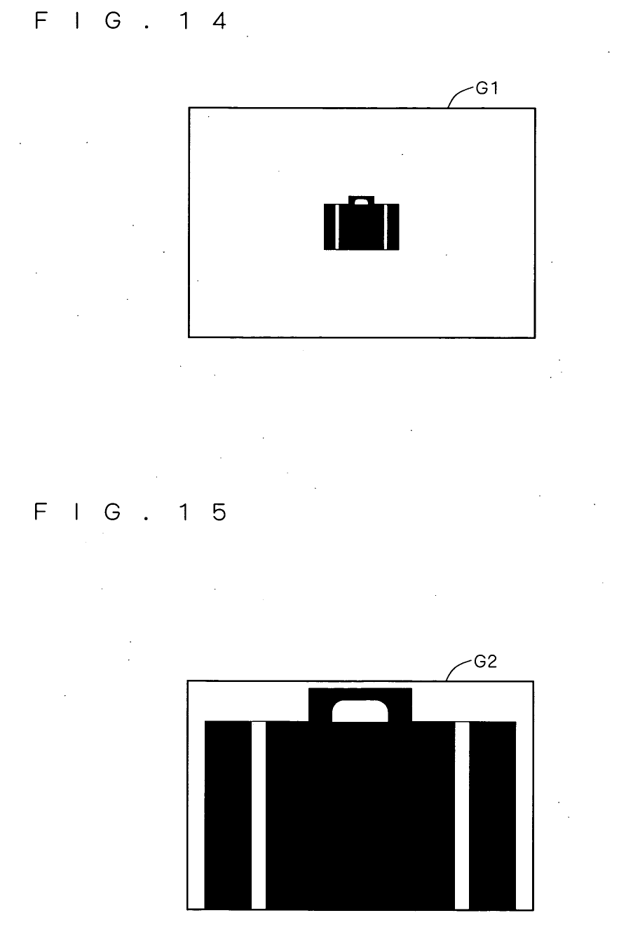

The image capturing apparatus 20 calculates the value of a focal length “f” satisfying the following equation (Equation 1) using the height H of the subject, the height “h” of the CCD, and the subject distance D, and changes the focal length “f” to the calculated value. Equation 1 is derived since image capturing magnification (image magnification) β is expressed as h/H or f/D (that is, β=h/H=f/D). Alternatively, Equation 1 is derived by a geometrical relation (f/D=h/H) as shown in FIG. 13.

$$f = D ⨯ \frac{h}{H} \qquad Equation 1$$

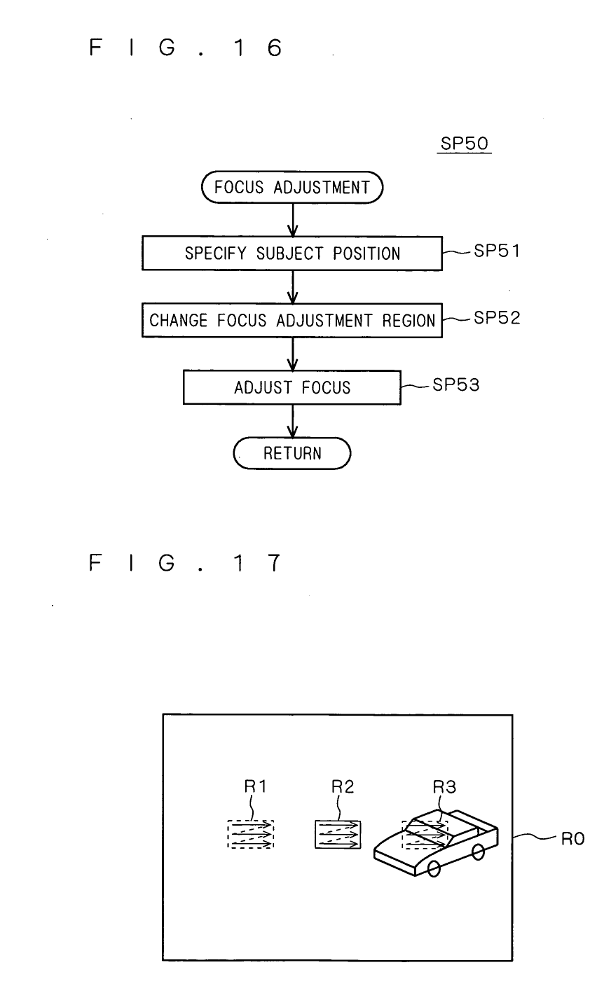

According to the focal length “f”, an image of the subject having the height H can be captured in the full height of the CCD. For example, as shown in FIG. 15, an image of the subject can be captured so as to be larger than that as shown in FIG. 14 (in this case, in the full screen). FIGS. 14 and 15 are diagrams showing images G1 and G2 of the same subject (bag) captured with different focal lengths f1 and f2, respectively (f1<f2).

By such a zoom adjusting operation, the zoom magnification (focal length) is controlled on the basis of the subject information (specifically, information on the subject size) from the RFID tag 11, so that the image of the subject can be captured in proper size in the screen. Although the height H itself of the subject is used in the above description, the present invention is not limited to the height H. A value obtained by adding an adjustment value AH to the height H of the subject may be substituted as the value H in Equation 1 to obtain the focal length f (f2). In such a manner, at the time of image capturing from various angles, the subject can be prevented from lying off the screen. It is also possible to automatically adjust the focal length in accordance with subject information and, after that, allow fine adjustment of the focal length by the user operation.

As described above, the image capturing apparatus 20 can properly capture an image of the subject in accordance with the subject information by setting the image capturing parameters (color correction parameter, exposure control value, focal length and the like) in accordance with subject information (color information, luminance information, size information and the like) from the RFID tag 11 and controlling the image capturing operation on the basis of the set image capturing parameters.

Although the case of setting the various image capturing parameters in accordance with the subject information itself and controlling the image capturing operation has been described (step SP12 in FIG. 6), the image capturing parameters (for example, focus lens position) can be set according to the reception level (also referred to as reception electric wave intensity, reception intensity, or communication intensity) at the time of reception of the subject information. Specifically, it is possible to select an AF area (also referred to as “focus detection region”) including a subject corresponding to an RFID tag having the highest reception level from a plurality of AF areas and change the focus lens position to the focus position of the selected AF area. The focus position of each AF area is obtained on the basis of an AF evaluation value in the AF area (for example, a contrast value of image data in the AF area).

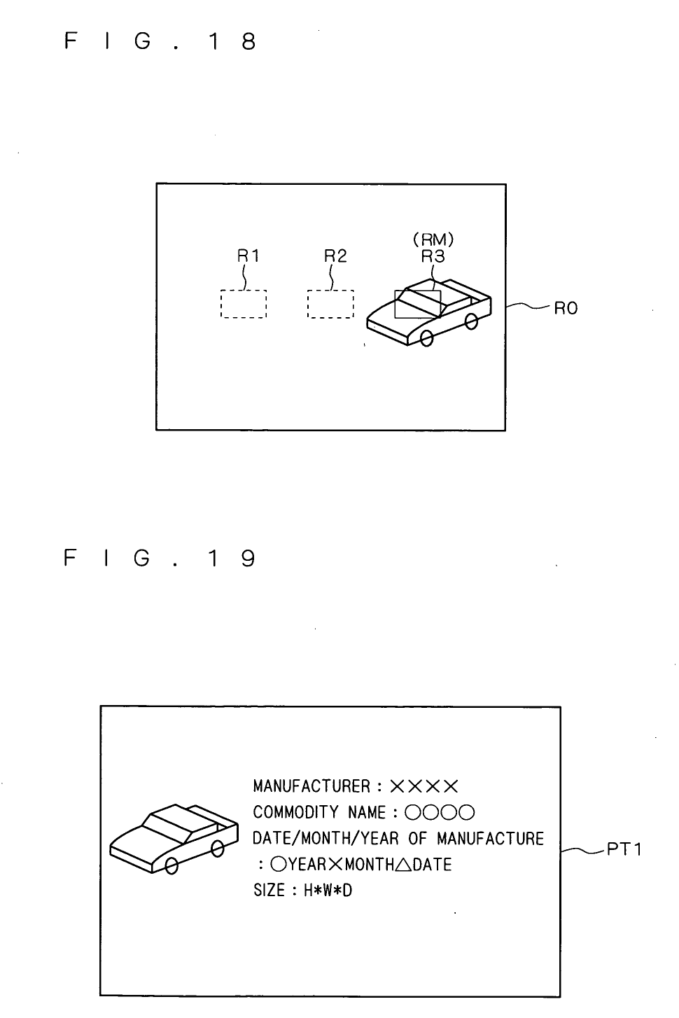

FIGS. 16 to 18 are diagrams showing an example of the above case. FIG. 16 is a flowchart showing a changing operation. FIGS. 17 and 18 are diagrams showing an AF area selecting operation. The processes in FIG. 16 may be executed, for example, in step SP12 in FIG. 6.

As shown in FIG. 16, first, in step SP51, the position of the subject is specified.

It is assumed herein that a scanning process and a communication process of the antenna 51 have been already performed on three AF areas R1, R2 and R3 in an image capturing region R0 as scan regions RS prior to the processes of FIG. 16 and reception levels LV1, LV2 and LV3 corresponding to the three AF areas R1, R2 and R3, respectively, were calculated at the time of scan. The reception levels LV1, LV2 and LV3 are calculated as reception levels in communication with the RFID tags 11 provided for the subjects in the AF areas R1, R2 and R3, respectively.

In step SP51, it is regarded that a main subject exists in an AF area RM (also referred to as maximum reception level area) corresponding to the highest reception level among the three reception levels LV1, LV2 and LV3. It is assumed herein that the reception level LV3 is the highest and the AF area R3 is the maximum reception level area RM.

The maximum reception level area RM (AF area R3 in FIG. 18) is selected as a focus adjustment target region (focus target region) from the plurality of AF areas (step SP52). By the selecting operation, even in the case where the AF area R2 in the center is selected as the focus adjustment target region as shown in FIG. 17, the state is changed to the state where the AF area R3 on the right side is selected as the focus adjustment target region as shown in FIG. 18.

Further, a focus adjusting operation is performed so that focus is achieved on the subject in the maximum reception level area RM (step SP53). More specifically, the contrast in the AF area R3 is calculated in a plurality of images corresponding to each focus lens position (the position of the focus lens 35), the focus lens position corresponding to the image having the highest contrast among the plurality of images is obtained as the focus position, and the focus lens 35 is moved to the focus position.

By such a focus operation, the main subject is determined and the focus lens position is controlled on the basis of the reception level in communication with the RFID tag.

Reproducing Operation

A reproducing operation in the image capturing apparatus 20 will now be described.

In the playback mode, the image capturing apparatus 20 reads the image file PF (FIG. 8) of an image to be reproduced from the recording medium 38, and displays a playback screen PT1 of the image to be reproduced on the LCD 22.

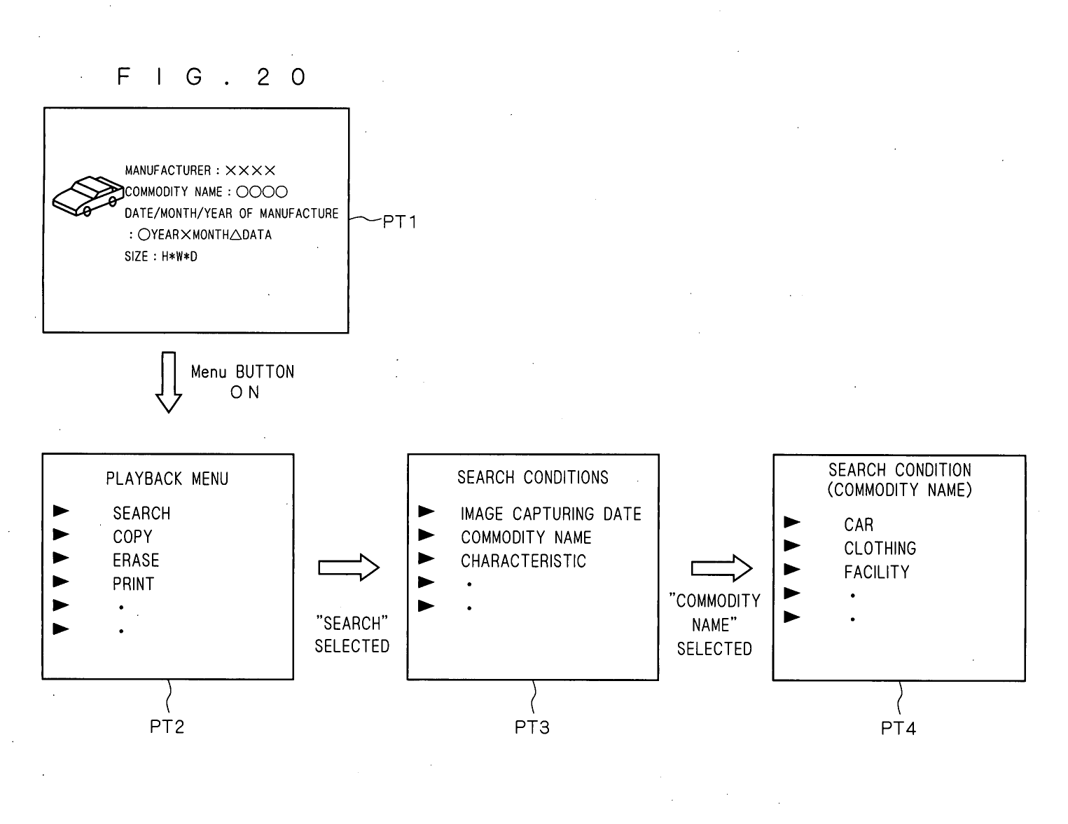

FIG. 19 is a diagram showing the playback screen PT1 on the LCD 22. On the playback screen PT1, a reproduced image based on the image data DP of the image file PF is displayed, and subject information in the IC tag information TI in the image file PF is overlaid on the reproduced image. Specifically, the manufacturer name of a commodity (subject), the commodity name, the date/month/year of manufacture, and size are displayed as the subject information.

When the IC tag information TI in the image file PF is read and the subject information based on the IC tag information TI is displayed together with a reproduced image as described above, information of the subject to be reproduced can be easily viewed.

FIGS. 20 to 22 are diagrams showing state transition in the playback mode.

As shown in FIG. 20, when the menu button 23a is depressed in a state where the playback screen PT1 is displayed on the LCD 22, a playback menu screen PT2 is displayed on the LCD 22. In the playback menu screen PT2, menu items such as “search”, “copy”, “erase”, and the like are displayed. The items other than “search”, for example, the items of “copy” and “erase” correspond to reproducing processes (copying process and erasing process) to be performed on an image on the playback screen PT1 displayed immediately before the playback menu screen PT2. The item of “search” corresponds to a process of retrieving an image matching a desired condition from a plurality of images in a memory card.

First, “search” will be described.

As shown in FIG. 20, when “search” is selected by operating the four-way key 23b on the playback menu screen PT2, a screen PT3 for designating a search condition is displayed on the LCD 22. On the screen PT3, conditions such as “image capturing date”, “commodity name”, “characteristic”, and the like are displayed. When a desired condition is selected from the conditions, a screen PT4 for designating a more-detailed condition is displayed on the LCD 22. FIG. 20 shows the screen PT4 which is displayed in the case where “commodity name” is selected on the screen PT3. On the screen PT4, detailed search conditions such as “car”, “clothing”, “facility” and the like are displayed. In such a manner, search conditions are sequentially added and targets are narrowed down. After that, an image matching the search conditions is selected and displayed on the LCD 22.

The searching operation is performed with reference to the IC tag information TI and the image tag information TP attached to each image. The IC tag information TI (FIG. 8) is information received from the RFID tag 11 and automatically stored so as to be associated with the image data DP. Since the IC tag information TI is used as information for search, it is unnecessary to newly input a keyword of the search or the like. The effort to input the keyword or the like can be omitted. Therefore, a larger number of targets can be easily set as targets of search. That is, an accurate searching operation can be easily realized.

“Copy” will now be described.

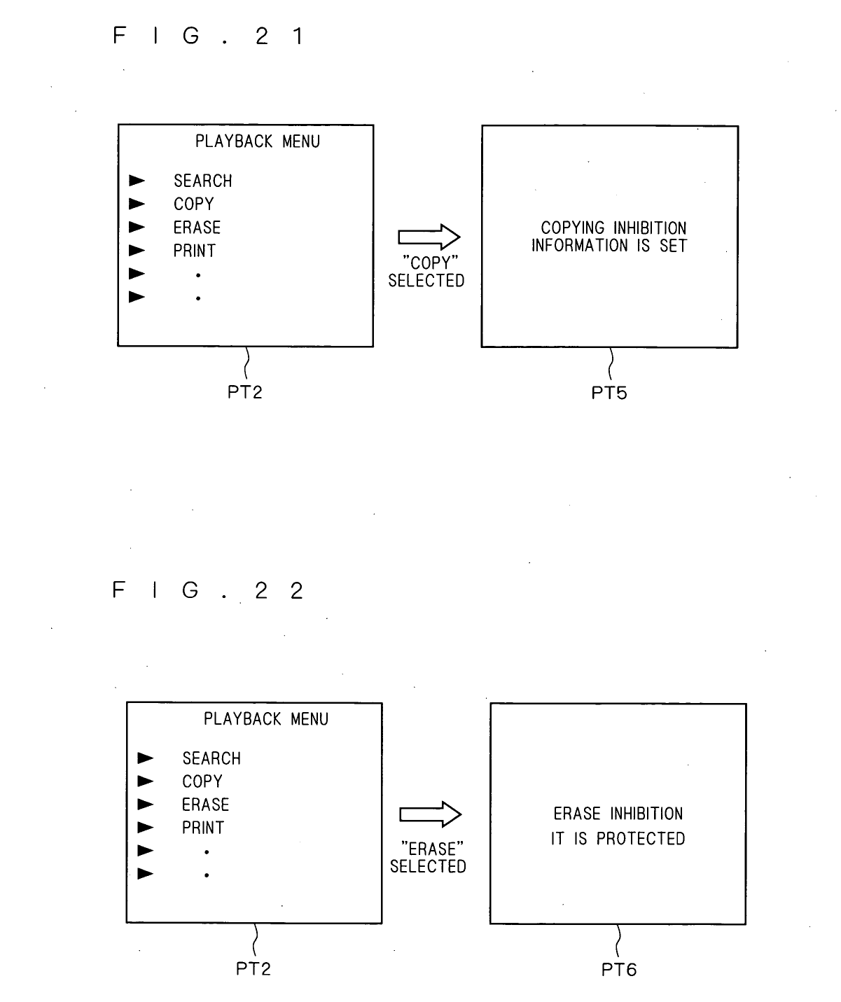

When “copy” is selected on the playback menu screen PT2, as a rule, a copying process is executed, and a copy image (image file) of the image displayed on the immediately preceding playback screen PT1 is generated in a designate folder. Prior to execution of the copying process, the image capturing apparatus 20 determines whether or not information designated to be copy-protected is included in the IC tag information (subject information) TI of the image file PF to be copied. In the case where information designated to be copy-protected is included, a warning screen PT5 as shown in FIG. 21 is displayed for a predetermined period to let the user know that copy protect is designated, and the program returns to the screen PT2 without performing the copying operation. In such a manner, on the basis of copy inhibition designation information recorded in the RFID tag 11 provided for the subject, inhibition of the copying operation in the image capturing apparatus 20 can be realized.

Further, “erase” will be described.

When “erase” is selected on the playback menu screen PT2, as a rule, an erasing process is executed, and an image (image file) displayed on the immediately preceding playback screen PT1 is erased. Prior to execution of the erasing process, the image capturing apparatus 20 determines whether information designating erase inhibition is included in the IC tag information (subject information) TI in the image file PF to be erased or not. In the case where information designating erase inhibition is included, a warning screen PT6 as shown in FIG. 22 is displayed for a predetermined period to let the user know that erase inhibition is designated, and the program returns to the screen PT2 without performing the erasing operation. In such a manner, on the basis of erase inhibition designation information recorded in the RFID tag 11 provided for the subject, inhibition of the erasing operation in the image capturing apparatus 20 can be realized.

3. Others

Although the preferred embodiment of the present invention has been described above, the present invention is not limited to the above description.

For example, the case where the data designating the color information of the subject is expressed in the L*a*b* colorimetric system has been described in the foregoing preferred embodiment. The present invention is not limited to the preferred embodiment and data may be expressed in any of other various colorimetric systems.

Although the case of warning the user of inhibition of the operation of capturing an image of the subject by displaying a warning on the LCD 22 in step SP 10 in FIG. 6 has been described in the foregoing preferred embodiment, a warning may be given by other means such as output of sound.

While the invention has been shown and described in detail, the foregoing description is in all aspects illustrative and not restrictive. It is therefore understood that numerous modifications and variations can be devised without departing from the scope of the invention.

What is claimed is:

1. An image capturing apparatus comprising:
a receiver for receiving subject information stored in an IC tag provided for a subject by performing wireless communication with said IC tag; and
a controller for controlling an image capturing operation on the basis of the subject information received by said receiver.

2. The image capturing apparatus according to claim 1, wherein
said controller sets image capturing parameters in accordance with said subject information and controls the image capturing operation on the basis of the set image capturing parameters.

3. The image capturing apparatus according to claim 2, wherein
said subject information includes at least color information on colors of the subject, and
said controller performs color correction on a captured image in accordance with the color information.

4. The image capturing apparatus according to claim 2, wherein
said subject information includes at least luminance information on luminance of the subject, and
said controller performs an exposure control in accordance with the luminance information.

5. The image capturing apparatus according to claim 2, wherein
said subject information includes at least size information on size of the subject, and
said controller controls focal length of a taking lens in accordance with the size information.

6. The image capturing apparatus according to claim 1, wherein
said subject information includes at least image capturing inhibition information, and
said controller controls an image capturing operation in accordance with the image capturing inhibition information.

7. The image capturing apparatus according to claim 6, wherein
said controller inhibits the image capturing operation on the basis of the image capturing inhibition information.

8. The image capturing apparatus according to claim 6, wherein
said controller gives a warning on the basis of the image capturing inhibition information.

9. The image capturing apparatus according to claim 1, wherein
said controller also controls an image capturing operation in accordance with a communication level in said wireless communication.

10. The image capturing apparatus according to claim 9, wherein
said controller determines a focus adjustment target region in accordance with a reception level.

11. The image capturing apparatus according to claim 10, wherein
said controller selects a region having the highest reception level from a plurality of regions as said focus adjustment target region and performs a focus adjusting operation.

12. The image capturing apparatus according to claim 1, further comprising:
a recorder for recording subject information received by said receiver and a captured image so as to be associated with each other on a recording medium, wherein
said controller also controls an operation of reproducing the captured image recorded on said recording medium on the basis of said subject information.

13. The image capturing apparatus according to claim 12, wherein
said controller searches for an image related to said subject information on the basis of the subject information.

14. The image capturing apparatus according to claim 12, wherein
said subject information includes at least information on copying of an image, and
said controller controls copying of an image related to the subject information on the basis of the copying information.

15. The image capturing apparatus according to claim 12, wherein
said subject information includes at least information on erasure of an image, and
said controller controls an operation of erasing an image related to the subject information on the basis of the information on erasure.

16. The image capturing apparatus according to claim 1, further comprising:
a display for displaying subject information received by said receiver.

17. A method for controlling an image capturing apparatus capable of receiving information stored in an IC tag, the method comprising the steps of:
performing wireless communication with an IC tag provided for a subject;
receiving subject information stored in said IC tag; and
controlling an image capturing operation on the basis of the received subject information.
